(19) United States
(12) Patent Application Publication
(10) Pub. No.: US 2016/0350858 A1
(43) Pub. Date: Dec. 1, 2016

(54) AUTOMATED FUND REALLOCATION BASED ON GOAL PROGRESS

(71) Applicant: BANK OF AMERICA CORPORATION, CHARLOTTE, NC (US)

(72) Inventors: Katherine Dintenfass, Charlotte, NC (US); Alicia C. Jones-McFadden, Fort Mill, SC (US); Jeanne Ferullo Connolly, Braintree, MA (US); David M. Grigg, Rock Hill, SC (US); Sahil Bahri, Chicago, IL (US); Sonny Tai, Chicago, IL (US); Markondapatnaikuni Samba Siva Patnaik, Chicago, IL (US); Craig Terrill, Barrington Hills, IL (US)

(21) Appl. No.: 14/723,186

(22) Filed: May 27, 2015

(51) Int. Cl. G06Q 40/06; G06Q 20/10

(52) U.S. Cl. CPC G06Q 40/06; G06Q 20/10

(57) ABSTRACT

A system and related embodiments are presented that establishes a goal guarantee for a user that provides the user a guarantee of acquiring, at a future date, a life goal based on the user providing a predetermined funding amount over time to a life goal account. The life goal includes goods, real estate and/or services. The predetermined funding amount is determined based at least in part on a predicted future cost for the goal and an uncertainty calculation associated with the user. Once funds are accumulated in the life goal account, the invention provides for automatically reallocating funds in the life goal account from a higher uncertainty investment to a lower uncertainty investment in response to one or more predetermined triggering events, such as dates, amount thresholds, meeting predetermined price thresholds for the goal or components of the goal.

### INCORPORATION BY REFERENCE

To supplement the present disclosure, this application further incorporates entirely by reference the following commonly assigned patent applications:

| | | | |
|---|---|---|---|
| Docket Number | U.S. patent application Ser. No. | Title | Filed On |

| | | |
|---|---|---|
| 6508US1.014033.2439 | GENERATING A ONE-CLICK | Concurrently |
| | FINANCIAL PLAN | Herewith |
| 6510US1.014033.2440 | A SYSTEM FOR NETWORK | Concurrently |
| | PAIRING OF INVESTORS AND | Herewith |
| | ADVSIORS BASED ON | |
| | INVESTOR INFORMATION | |
| | ANALYTICS | |
| 6515US1.014033.2442 | AN INTEGRATED FINANCIAL | Concurrently |
| | AND HEALTH MONITORING | Herewith |
| | SYSTEM UTILIZING | |
| | WEARABLE DEVICES | |
| 6517US1.014033.2443 | MODIFYING AN ESTIMATED | Concurrently |
| | FINANCIAL PLAN | Herewith |
| 6518US1.014033.2444 | GOAL GUARANTEE SYSTEM | Concurrently |
| | | Herewith |

### FIELD

In general, embodiments of the invention relate to financial planning and, more particularly, establishing a life goal account that accumulates funds that are allotted for a goal that is being guaranteed and automatically managing the funds accumulated in the account by reallocating funds from a higher investment vehicle to a lower investment vehicle in response to a triggering event.

### BACKGROUND

People typically have dreams or aspirations of obtaining something of high-value in the future. For example, a person may desire to one day own a vacation home, a boat, a luxury automobile or have a desire to travel the world. While people may set aside funds for such life-long pursuits, in many instances, over the course of time the funds that are set aside get allocated to other more important concerns (e.g., mortgage payments, medical bills and the like) or the funds that are set aside prove to be insufficient to purchase the life goal due to inflation, rising costs and the like.

Therefore, a need exists to develop systems, apparatus, computer program products, and the like that assure that an individual's life goal is attained. In addition a need exists to automate the investment strategy for funds that the individual accumulates in a goal-based financial account.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, methods or the like that establish a life a goal guarantee for a user, in which, a goal guarantor, such as a financial institution or the like, guarantee the goal to the user, at a future date, based on the user providing a predetermined funding amount, over time, to a life goal account. The goal includes one or more of tangible goods, real estate or services. The predetermined funding amount is determined based at least in part on a predicted future cost for the goal and an uncertainty calculation associated with the user. Once the life goal account has been established, the invention further provides for automatically reallocating at least a portion of funds accumulated in the life goal account from a higher uncertainty investment to a lower uncertainty investment in response to one or more predetermined triggering events. The predetermined triggering events may predetermined dates, threshold amounts in the account, predetermined target prices for the goods, real estate or services or components that make up the good, real estate or services or determined optimal prices for the goods, real estate or services or components that make up the good, real estate or services.

A system for managing funds in a life goal account defines first embodiments of the invention. The system includes an apparatus having a computing platform including a memory and at least one processor in communication with the memory. The system additionally includes a goal guarantee module that is stored in the memory and executable by the processor. The goal guarantee module is configured to provide a user a guarantee of acquiring, at a future date, a life goal desired by the user based on the user providing a predetermined funding amount over time to a life goal account. The goal includes one or more of tangible goods, real estate or services. Further, the predetermined funding amount is determined based at least in part on a predicted future cost for the goal and an uncertainty calculation associated with the user. In addition, the system includes a goal fund reallocation module that is stored in the memory and executable by the processor. The goal fund reallocation module is configured to automatically reallocate at least a portion of funds accumulated in the life goal account from a higher uncertainty investment to a lower uncertainty investment in response to one or more predetermined triggering events.

In specific embodiments of the system, the triggering events that trigger automatic reallocations are predetermined dates. In other embodiments of the system, the triggering events that trigger automatic reallocation are meeting predetermined amount thresholds accumulated in the life goal account.

In still further embodiments of the system, the triggering events that trigger automatic reallocation are meeting a predetermined target prices for acquiring components that comprise the goods, real estate or services defining the goal or logical determination that an optimal price currently exists for acquiring components that comprise the goods, real estate or services defining the goal. In such embodiments of the system, the goal fund reallocation module may be further configured to reallocate a remaining balance of the funds accumulated in the life goal account from the higher uncertainty investment to the lower uncertainty investment in response to acquiring the components at one of the predetermined target price or the determined optimal price.

In other embodiments of the system, the fund reallocation module is further configured to automatically reallocate at least a portion of funds accumulated in the life goal account from a higher uncertainty investment to a lower uncertainty investment, defined as acquisition of the goods, real estate or services that comprise the goal, in response to one or more predetermined triggering events, wherein the lower uncertainty investment. In such embodiments of the system, the triggering events is one of meeting a predetermined target prices for acquiring the goods, real estate or services defining the goal or logical determination that an optimal price currently exists for acquiring the goods, real estate or services defining the goal.

A method for managing funds in a life goal account defines second embodiments of the invention. The method includes establishing a goal guarantee for a user that provides the user a guarantee of acquiring, at a future date, a life goal based on the user providing a predetermined funding amount over time to a life goal account. The goal includes one or more of tangible goods, real estate or services. The predetermined funding amount is determined based at least in part on a predicted future cost for the goal and an uncertainty calculation associated with the user. The method further includes automatically reallocating at least a portion of funds accumulated in the life goal account from a higher uncertainty investment to a lower uncertainty investment in response to one or more predetermined triggering events.

A computer program product including a non-transitory computer-readable medium defines third embodiments of the invention. The computer readable medium includes a first set of codes for causing a computer to establishing a goal guarantee for a user that provides the user a guarantee of acquiring, at a future date, a life goal based on the user providing a predetermined funding amount over time to a life goal account. The goal includes one or more of tangible goods, real estate or services. The predetermined funding amount is determined based at least in part on a predicted future cost for the goal and an uncertainty calculation associated with the user. The computer-readable medium includes a second set of codes for causing a computer to automatically reallocate at least a portion of funds accumulated in the life goal account from a higher uncertainty investment to a lower uncertainty investment in response to one or more predetermined triggering events.

Thus, systems, apparatus, methods, and computer program products herein described in detail below provide for managing funds in a life goal account so insure the purchase of the goods, real estate and/or services associated with the goal. Since investment strategy for a life goal account typically provides for the funds to be invested in a higher uncertainty vehicle at the onset of the account, the present invention provides for automatically reallocating the funds from a higher uncertainty investment vehicle/account to a lower uncertainty investment vehicle account in response to a triggering event. The triggering event may be predetermined date(s), predetermined threshold amounts, predetermined target price(s) for the goal or components of the goal, or dynamic determination of a current price being optimal for buying/acquiring the goal or components of the goal.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of a system for configuring establishment of a life goal, in accordance with embodiments of the present invention;

FIG. 2 provides a block diagram of the apparatus configured for generating a goal guarantee, in accordance with embodiments of the present invention;

FIG. 3 provides a block diagram of an apparatus configured for managing fund reallocation in a life goal account, in accordance with embodiments of the present invention;

FIG. 4 depicts a flow diagram of a method for establishing a guaranteed life goal, in accordance with embodiments of the present invention; and

FIG. 5 depicts a flow diagram of a method for managing fund reallocation in a life goal account, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for providing apparatus, systems, computer program products, methods or the like that establish a life a goal guarantee for a user, in which, a goal guarantor, such as a financial institution or the like, guarantee the goal to the user, at a future date, based on the user providing a predetermined funding amount, over time, to a life goal account. The goal includes one or more of tangible goods, real estate or services. The predetermined funding amount is determined based at least in part on a predicted future cost for the goal and an uncertainty calculation associated with the user. Once the life goal account has been established, the invention further provides for automatically reallocating at least a portion of funds accumulated in the life goal account from a higher uncertainty investment to a lower uncertainty investment in response to one or more predetermined triggering events. The predetermined triggering events may predetermined dates, threshold amounts in the account, predetermined target prices for the goods, real estate or services or components that make up the good, real estate or services or determined optimal prices for the goods, real estate or services or components that make up the good, real estate or services.

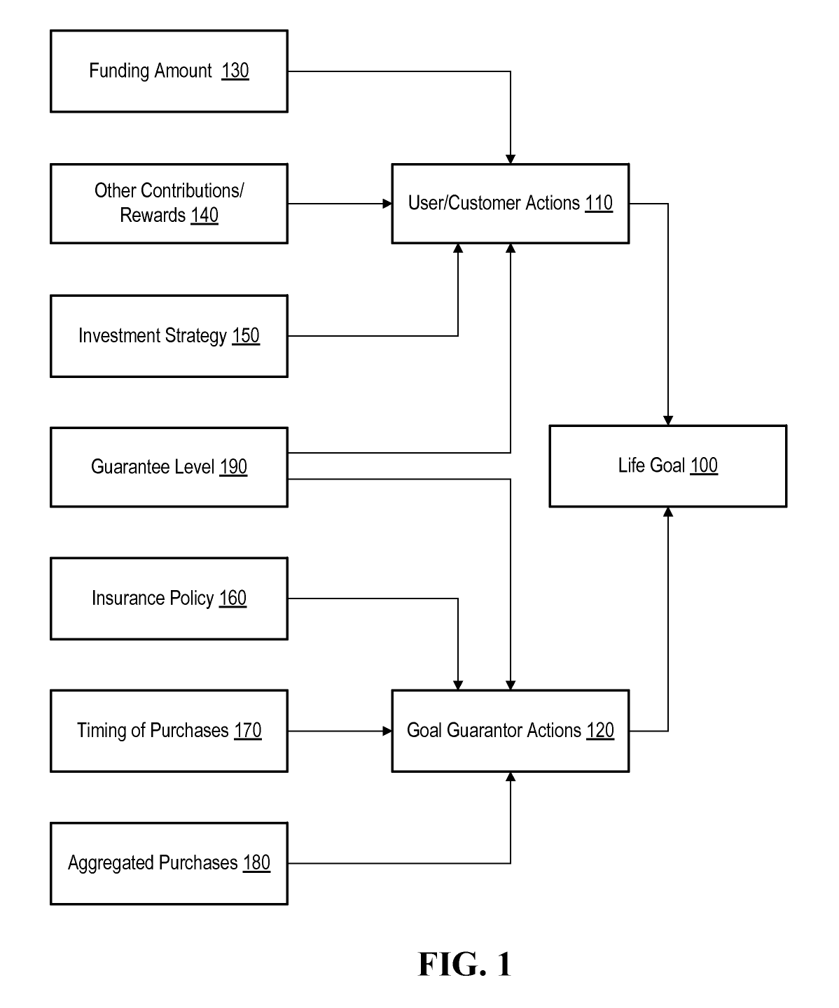

Referring to FIG. 1 a block diagram is presented of a methodology for establishing a guaranteed life goal 100, in accordance with embodiments of the present invention. The life goal may be any good(s) and/or service(s) desired by a user (e.g., financial institution customer) at a future date. Goods, as used herein, includes real estate, which comprises real property and a related structure. Thus, for example, a life goal may include a vacation home, a boat, the ability to travel (e.g., a specified number of vacation trips over a designated time period) and the like. In specific embodiments the future date may coincide with a retirement date, although in other embodiments the future date may be any date in the future. In specific embodiments of the invention the life goal may extend for an undetermined period of time, such as a life goal of being able to travel upon retirement for the remainder of the user's/customer's lifetime. Additionally, it should be noted that the life goal may comprise both good(s) and services(s). Moreover, it should be evident that a life goal may include multiple components, such as multiple trips/vacations, and/or each trip/vacation having multiple components, such as travel, lodging and the like.

The life goal 100 comprises both user/customer actions 110 and goal guarantor actions 120. The goal guarantor may be a financial institution or any other entity capable of guaranteeing a goal for a user/customer. User/customer actions 120 include, but are not limited to, a funding amount 130, other contributions/rewards 140, an investment strategy 150 and a guarantee level 190. The investment strategy 150, the other contributions/rewards 140 and the guarantee level 190 are used to assist the goal guarantor in determining the funding amount 130. The funding amount is the amount the user/customer agrees to provide, typically over time, to a life goal account. The funding amount may be defined as the lump sum amount or as the individual payments that the user/customer makes to the life goal account on a predetermined schedule, such as monthly or the like. The funding amount is determined based on the monetary amount required to be accumulated over time to satisfy a determined future value/cost of the life goals (i.e., what the goads and/or services are predicted to cost at the future date or during the future time period).

The investment strategy 150 may be selected by the user/customer. For example the user/customer may select from a conservative investment strategy, a moderate investment strategy or an aggressive investment strategy. In specific embodiments of the invention, the goal guarantor may suggest/recommend a specific investment strategy 150 for the user/customer, based on the user's identified life goal and the user's current financial status and/or historical financial performance. In specific embodiments of the invention, an aggressive (i.e., higher uncertainty) investment strategy may be selected by and/or recommended for the user/customer at the onset of the goal guarantee process and as funds are accumulated in the life goal account the accumulated funds may be transferred to moderate or conservative investment platform.

The other contributions/rewards 140 may include cash-back rewards related to other financial products offered by the goal guarantor, such as cash-back related to credit card accounts or the like. The user/customer may have pre-existing rewards, associated with a pre-existing financial institution product, which may be earmarked for the life goal account at the inception of the goal guarantee or the user/customer may be offered financial products having related rewards, such as cash-back rewards, in conjunction with the goal guarantee offer as a means of offsetting the funding amount.

The guarantee level 190 may be defined as a percentage of the overall cost of the life goal that the user/customer's desires the goal guarantor to guarantee. In specific embodiments, the user/customer may select a desired guarantee level or percentage (e.g., 50%. 75%, 100% or the like). In other embodiments of the invention, the guarantee level 190 may be determined by the goal guarantor based on the user's/customer's historical financial performance. While in still other specific embodiments of the invention, the guarantee level 190 may be determined based on both user/customer selection of a desired guarantee level and the user's/customer's historical financial performance. In specific embodiments of the invention the default guarantee level may be set to 100% unless a user/customer input is received requesting a lower level of guarantee and/or the user's/customer's historical financial performance dictates a lower level of guarantee.

Goal guarantor actions 120 include, but are not limited to, an insurance policy 160, timing of purchases 170 and aggregated purchasing 180. The insurance policy 160, specifically the amount of insurance required, may be based on the uncertainty of the user/customer or uncertainty associated with the goal. For example, from the user/customer perspective an uncertainty calculation may be based on the likelihood of the user/customer losing income stream (i.e., lost employment or the like), past financial performance (e.g., credit score or the like), and the life expectancy of the user/customer (based on the life goal being a recurring service, such as annual travel while in retirement or the like). From the goal perspective an uncertainty calculation may be based on a likelihood of miscalculation of future value/cost of the goal, and likelihood of fluctuations in interest rates. Other factors, such as the level of guarantee 190 and the investment strategy 150 may factor into determining the amount of insurance required.

Additionally besides an insurance policy 160, the goal guarantor may take other actions to insure that the goal is attained by the user/customer and/or offset costs associated with obtaining the goal for the user/customer. Such other actions include timing of purchases 170 and aggregated purchasing 180. Timing of purchases assumes that in certain instance it may be advantageous from a purchase price perspective to purchase the goal or components of the goal prior to the future date that the user/customer has identified as the date on which they desire the goal to come to fruition or begin. For example, specified travel goals will have a transportation component and cost (e.g., airfare), a lodging component and cost and the like. As such, the goal guarantor may employ a means to monitor pricing associated with identified life costs, to time the purchase of the life goal and/or components of the life goal so as to purchase the life goal or components of the life goal when the pricing is perceived to be or predicted to be at a minimum. In another example, if a user's/customer's life goal is a vacation home, the property on which the vacation home is to be built may be purchased as a separate component, in advance of building the dwelling on the property.

Aggregated purchasing 180 assumes that the goal guarantor will receive price discounts from purchasing multiple goals or components of goals either simultaneously or over time from a vendor. In this regard, aggregated purchasing also assumes that multiple goal guarantee users/customers will have the same or similar goals. For example, multiple users/customers may have a goal of travel to the same destination or multiple users/customers may desire a second/vacation home at the same location. As such, aggregating purchasing provides for monitoring the life goals and components of the life goals, determining which life goals or components are the same or similar for the purpose of grouping goals and/or components and determining aggregating purchasing opportunities for grouped goals or components of goals. Additionally, aggregated purchasing 170 may be implemented in unison with timing of purchases 170 so as to purchase the multiple life goals or multiple components of the life goal when the pricing is perceived to be or predicted to be at a minimum.

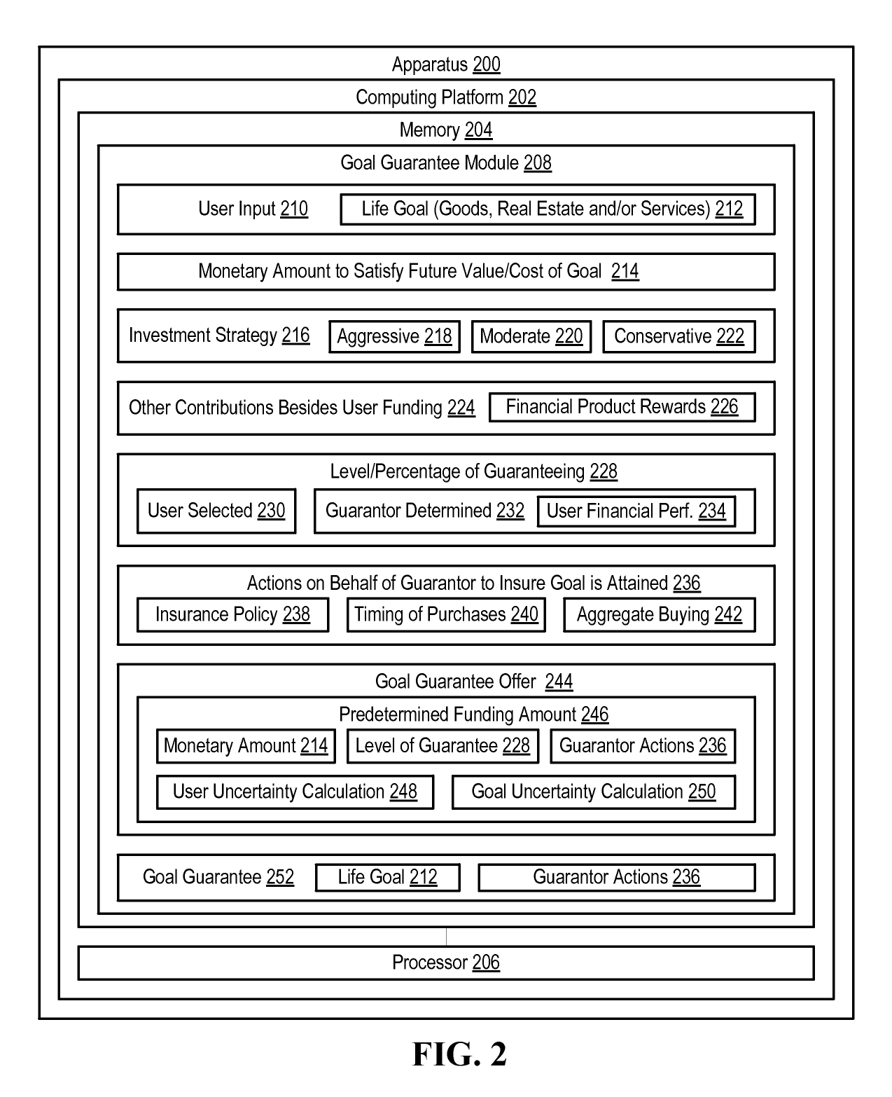

Referring to FIG. 2, a block diagram is presented of an apparatus 200, which is configured for establishing a life goal guarantee, in accordance with embodiments of the present invention. FIG. 2 highlights various alternate embodiments of the invention. The apparatus 200 may include one or more of any type of computing device, such as multiple servers or the like. The present apparatus and methods can accordingly be performed on any form of one or more computing devices.

The apparatus 200 includes computing platform 202 that can receive and execute algorithms, such as routines, and applications. Computing platform 202 includes memory 204, which may comprise volatile and non-volatile memory, such as read-only and/or random-access memory (RAM and ROM), EPROM, EEPROM, flash cards, or any memory common to computer platforms. Further, memory 204 may include one or more flash memory cells, or may be any secondary or tertiary storage device, such as magnetic media, optical media, tape, or soft or hard disk. Moreover, memory 204 may comprise cloud storage, such as provided by a cloud storage service and/or a cloud connection service.

Further, computing platform 202 also includes processor 206, which may be an application-specific integrated circuit (“ASIC”), or other chipset, processor, logic circuit, or other data processing device. Processor 206 or other processor such as ASIC may execute an application programming interface (“API”) (not shown in FIG. 2) that interfaces with any resident programs, such as goal guarantee module 208 and sub-modules associated therewith or the like stored in the memory 204 of the apparatus 200.

Processor 206 includes various processing subsystems (not shown in FIG. 2) embodied in hardware, firmware, software, and combinations thereof, that enable the functionality of apparatus 200 and the operability of the apparatus on a network. For example, processing subsystems allow for initiating and maintaining communications and exchanging data with other networked devices. For the disclosed aspects, processing subsystems of processor 206 may include any subsystem used in conjunction with goal guarantee module 208 and related algorithms, sub-algorithms, modules, sub-modules thereof.

Computer platform 202 may additionally include communications module (not shown in FIG. 2) embodied in hardware, firmware, software, and combinations thereof, that enables communications among the various components of the apparatus 200, as well as between the other networked devices. Thus, communication module may include the requisite hardware, firmware, software and/or combinations thereof for establishing and maintaining a network communication connection.

The memory 204 of apparatus 200 stores goal guarantee module 208 that is executable by the processor 206 and configured to establish life goal guarantees, in accordance with embodiments of the present invention. The goal guarantee module is configured to receive a user input 210 that identifies a life goal 212 that the user desires to attain at a future date. As previously noted, the life goal 212 may be good(s) or services(s) or a combination of good(s) and services(s), with goods including real estate (real property, which may include a structure). The user input 210 may provide for the user to define the life goal or the module 208 may be configured for the user to select the life goal and/or a life goal category from various life goal options. In addition, the user input 210 may include user selection/input of the future date on which the life goal is to be realized or on which the life goal is to commence.

The goal guarantee module 210 is further configured to determine a monetary amount 214 required to be accumulated over time to satisfy the future value/cost of the life goal. Determining the monetary amount 214 may initially include determine what the goal comprises or, more specifically, the components that make up the identified life goal. As such the goal guarantee module 210 predicts what the future value/cost of the life goal will be at the point in time at which the life goal will be purchased. It should be noted that the goal guarantor may purchase or otherwise acquire the life goal or components or the life goal prior to the future date on which the user/customer desires to attain/receive the life goal or begin the receiving the life goal. As such, determining the future value/cost takes into account a finite or predicted date on which the life goal is to be purchased and other factors associated with determining a future value cost, such as interest rates, inflation and the like. It should be noted that determination of the monetary amount 214 may, in certain embodiments, be configured to occur in real-time or near-real time upon identification of the life goal, while in other embodiments of the invention the determination of the monetary amount 214 may occur over a period of time, in due course, due to the complexity or other factors associated with the identified life goal 212.

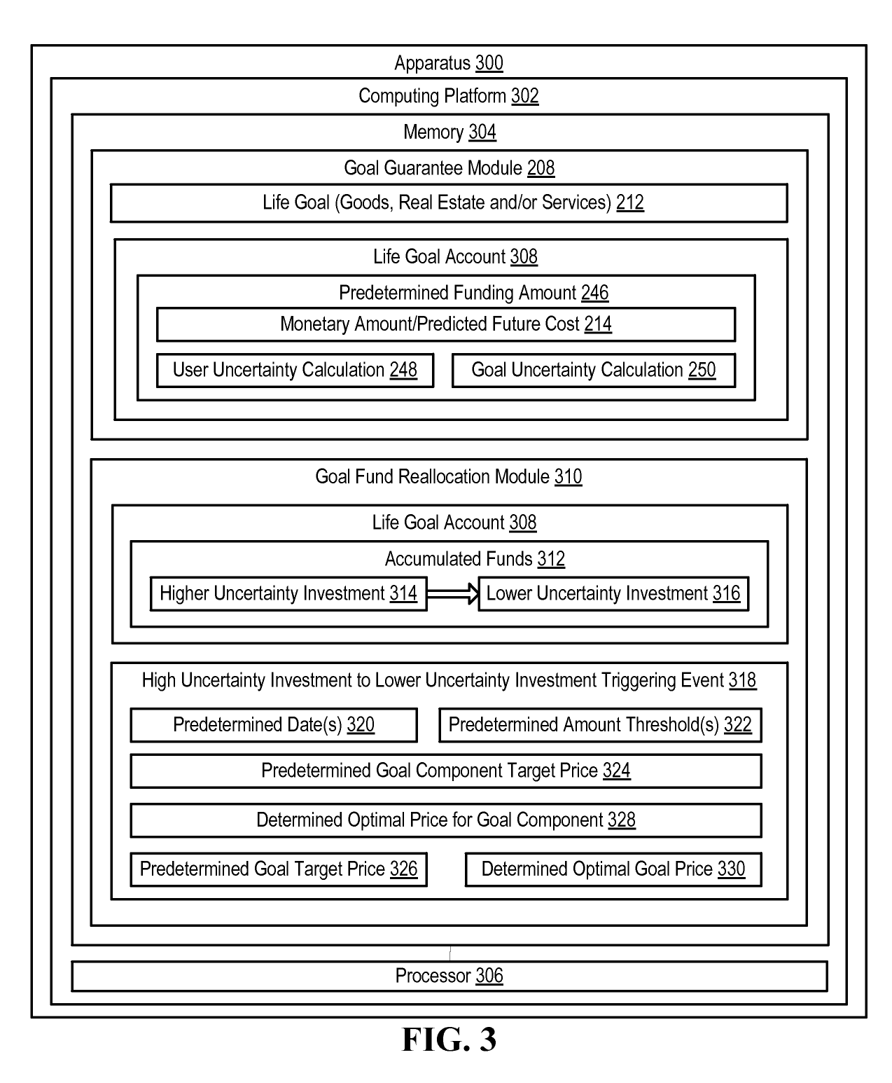

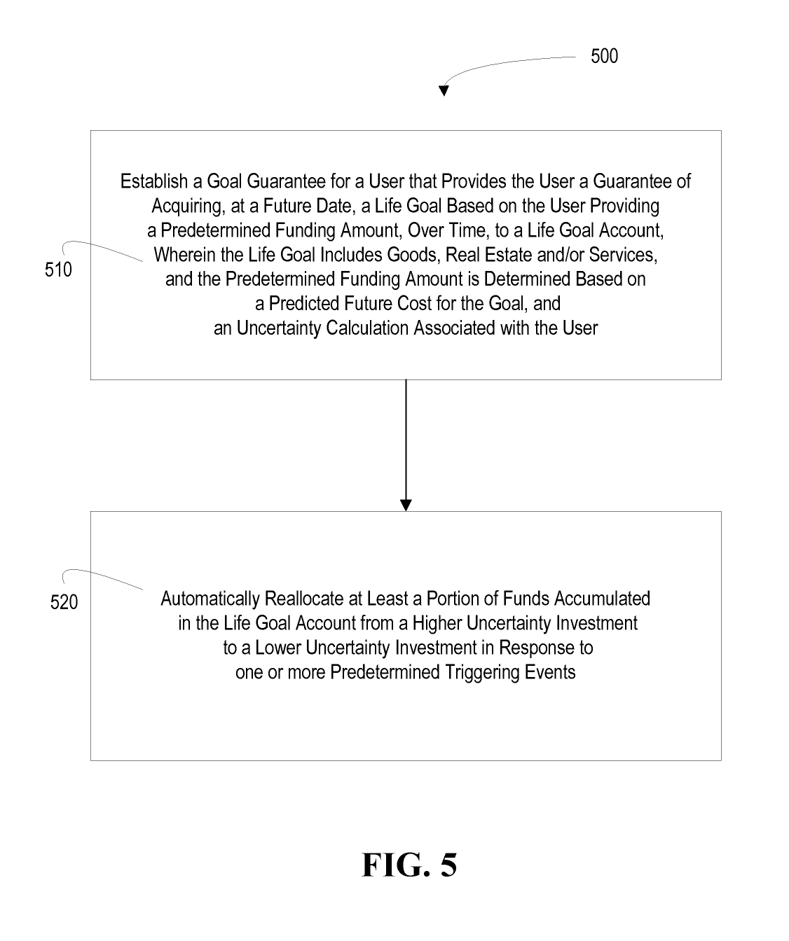

In specific embodiments of the invention, the goal guarantee module 208 may be configured to determine or identify an investment strategy 216 to be employed by the user/customer as a means of accumulating the monetary amount 214 needed to satisfy the future value/cost of the life goal 212. In specific embodiments of invention the goal guarantee module 208 is configured to allow the user/customer to select a strategy such as an aggressive (i.e., more uncertainty) strategy 218, a moderate strategy (i.e., less uncertainty) 220 or a conservative strategy (i.e., least uncertainty) 224. Moreover, the module 208 may be configured to allow the user/customer to change their investment strategy during the course of the period of time in which funds are being accumulated to account for the certainty of funds in the life goal account. As discussed in related to FIGS. 3 and 5 below, specific embodiments of the invention provide for accumulate funds in the life goal account to be automatically reallocated from high uncertainty investments to lower uncertainty investments in response to predetermined events, such as dates, amount thresholds and the like. In other embodiments of the invention, the goal guarantor may determine an investment strategy for the user/customer based on the user's/customer's financial profile, including income and/or financial performance history and/or the life goal. The determined investment strategy may be recommended to the user, such that the user may override the recommendation or the module 208 may be configured such that the determined investment strategy is mandated for the user/customer. Goal guarantor determination of the investment strategy is important to the goal guarantor since the goal guarantor is the entity guaranteeing the goal (e.g., insuring the goal) and, as such, the investment strategy may factor in to what actions are taken by the goal guarantor to insure the goal is attained (e.g., how much insurance is taken and the like).

Moreover, the goal guarantee module 208 may determine other contributions 224 besides user/customer funding which may be used to offset the monetary amount 214 needed to satisfy the future value/cost of the life goal 212. As previously discussed, the other contributions 224 may be financial product-related monetary rewards 226, such as cash-back associated with a credit card or the like. It certain instances the user/customer may have a pre-existing financial product tied to rewards, in which case, the module 208 may be configured to suggest to the user/customer that the rewards from the pre-existing product be designated for automatic deposit into the life goal account. In other embodiments, the module 208 may be configured to present an offer for a financial product having related goals in conjunction with the goal guarantee offer. In certain embodiments the financial product having rewards and the goal guarantee offers are tied together, such that acceptance of the goal guarantee offer provides for acceptance of the financial product offer, while in other embodiments of the invention the offers are configured to be mutually exclusive.

In addition, goal guarantee module 208 may be configured to determine/identify a level of guaranteeing 228 for the user/customer. In specific embodiment the level of guaranteeing 228 is defined as a percentage of the monetary amount need to be accumulated over time to satisfy the future value/cost of the life goal. The goal guarantee module 208 may be configured for user selection 230 of the level of guaranteeing 228. In such embodiment, the module 208 may configured to present the user/customer a series of radio buttons with each button associated with a different level of guarantee (e.g., 100%, 80%, 60% or the like) and/or entry field in which the user/customer can inputted their desired level of guarantee. In other embodiments of the invention, the level of guaranteeing may be guarantor determined 232 based on the user's/customer's current financial performance (i.e., accessing the user's/customer's financial records/accounts and/or credit score). In specific embodiments of the invention, the guarantor's determination may result in which different levels of guarantee are presented to the user for selection. For example, strong financial historical performance may result in the user being presented level of guaranteeing options up to and including 100%, while weaker financial historical performance may result in the user being presented level of guaranteeing options less than 100% (e.g., up to 75%, up to 50% or the like).

Additionally, goal guarantee module 208 may be configured to identify/determine actions 236 taken on behalf of the guarantor to insure that the goal is attained by the user/customer. As previously discussed the actions may include, but are not limited to, an insurance policy 238 (and related amount of insurance), timing of purchases 240 and aggregated purchasing 242. In specific embodiments of the invention the actions taken by the guarantor 236 may be determined and/or identified prior to making a goal guarantee offer to the user/customer, while in other embodiments, at least a portion, of the actions may be determined after the goal guarantee has been established (e.g., specific timing of purchases and aggregated purchasing may not be identified until after the goal guarantee has been established). However, the amount of insurance required may factor into the predetermined funding amount 246 required of the user/customer (i.e., the overall cost of the goal guarantee) and, as such, the determination of the insurance policy amount, which may take into account such factors as the user's financial historical performance, credit score and level of guaranteeing, may occur prior to making the goal guarantee offer to the user/customer.

The goal guarantee module is further configured to present to the user a goal guarantee offer 244 that requires the user/customer to provide a predetermined funding amount 246, over time, to a life goal and requires, at least a portion of the life goal to be guaranteed by the goal guarantor. Guaranteed means that the goal will be realized by the user/customer regardless of extraneous circumstances, such as loss of income/job, rises in cost related to the goal, and, in some embodiments, faulty investment strategy and the like. The predetermined funding amount, which may be regularly scheduled payments, such as monthly payments or the like, is determined based on the monetary amount 214, the level of guaranteeing 228 and an uncertainty calculation associated with the user 248. In alternate embodiments of the invention, the predetermined funding amount 246 may additionally be determined based on the guarantor actions 236 and an uncertainty calculation associated with the goal 250.

The uncertainty calculation associated with the user 248 may take into account the likelihood of the user/customer losing a source of income/employment (including health risks), the user's/customer's historical financial performance (e.g., credit score), uncertainty of user's/customer's investment strategy, user/customer life expectancy and the like. In those embodiments of the invention in which the goal guarantee module 208 bases the funding amount 246 on an uncertainty calculation associated with the goal 250 the calculation may take into account miscalculations in the future value/cost of the goal and/or goal components, fluctuations in interest rates.

In response to the user/customer accepting the goal guarantee offer 244, the determined guarantor actions 236 (or actions determined/identified post-offer acceptance) are performed by the goal guarantor to insure that the life goal 212 is attained by the user/customer.

Referring to FIG. 3, a block diagram is presented of an apparatus 300, which is configured for automatically reallocating funds in a life goal account from a higher uncertainty investment to a lower uncertainty investment, in accordance with embodiments of the present invention. FIG. 3 highlights various alternate embodiments of the invention. The apparatus 300 may include one or more of any type of computing device, such as multiple servers or the like. The present apparatus and methods can accordingly be performed on any form of one or more computing devices.

The apparatus 300 includes computing platform 302 that can receive and execute algorithms, such as routines, and applications. Computing platform 302 includes memory 304, which may comprise volatile and non-volatile memory, such as read-only and/or random-access memory (RAM and ROM), EPROM, EEPROM, flash cards, or any memory common to computer platforms. Further, memory 304 may include one or more flash memory cells, or may be any secondary or tertiary storage device, such as magnetic media, optical media, tape, or soft or hard disk. Moreover, memory 304 may comprise cloud storage, such as provided by a cloud storage service and/or a cloud connection service.

Further, computing platform 302 also includes processor 306, which may be an application-specific integrated circuit (“ASIC”), or other chipset, processor, logic circuit, or other data processing device. Processor 306 or other processor such as ASIC may execute an application programming interface (“API”) (not shown in FIG. 3) that interfaces with any resident programs, such as goal guarantee module 208 and sub-modules associated therewith or the like stored in the memory 304 of the apparatus 300.

Processor 306 includes various processing subsystems (not shown in FIG. 3) embodied in hardware, firmware, software, and combinations thereof, that enable the functionality of apparatus 300 and the operability of the apparatus on a network. For example, processing subsystems allow for initiating and maintaining communications and exchanging data with other networked devices. For the disclosed aspects, processing subsystems of processor 206 may include any subsystem used in conjunction with goal guarantee module 208 and related algorithms, sub-algorithms, modules, sub-modules thereof.

Computer platform 302 may additionally include communications module (not shown in FIG. 3) embodied in hardware, firmware, software, and combinations thereof, that enables communications among the various components of the apparatus 300, as well as between the other networked devices. Thus, communication module may include the requisite hardware, firmware, software and/or combinations thereof for establishing and maintaining a network communication connection.

The memory 304 of apparatus 300 stores goal guarantee module 208 that is executable by the processor 206 and configured establish a goal guarantee for a user/customer that provides the user a guarantee of attaining/acquiring, at a future date, a life goal 212 based on the user providing a predetermined funding amount 246 over time to a life goal account 306. As previously discussed, the life goal 212 may be good(s) or services(s) or a combination of good(s) and services(s), with goods including real estate (real property, which may include a structure).

The predetermined funding amount 246, which may be regularly scheduled payments, such as monthly payments or the like, is determined based on the monetary amount/future value/cost of the goal 214, and an uncertainty calculation associated with the user 248. In alternate embodiments of the invention, the predetermined funding amount 246 may additionally be determined based on the guarantor actions 236, an uncertainty calculation associated with the goal 250 and a level of guaranteeing 228.

As previously discussed, the uncertainty calculation associated with the user 248 may take into account the likelihood of the user/customer losing a source of income/employment (including health risks), the user's/customer's historical financial performance (e.g., credit score), uncertainty of user's/customer's investment strategy, user/customer life expectancy and the like. In those embodiments of the invention in which the goal guarantee module 208 bases the funding amount 246 on an uncertainty calculation associated with the goal 250 the calculation may take into account miscalculations in the future value/cost of the goal and/or goal components, fluctuations in interest rates.

The memory 304 of apparatus 300 additionally stores goal fund reallocation module 308 that is executable by processor 306 and configured to automatically reallocate at least a portion of the accumulated funds 312 in the life goal account 308 from a higher uncertainty investment 314 to a lower risk investment 316 in response to one or more predetermined fund reallocation triggering events 318. It should be noted that fund reallocation may occur multiple times in the life of a goal guarantee, such that each instance of a triggering event may result in the funds being reallocated to a less uncertain investment. The present invention assumes that the user and/or goal guarantor will initially place accumulate funds in a higher uncertainty investment vehicle with the hopes of growing the funds at a faster rate than would be experienced in a less uncertain investment vehicle. By automatically reallocating funds from the higher uncertainty investment 314 to a lower uncertainty investment 316 based on triggering events, the present invention eliminates the need for manual tracking and management of the funds, which could otherwise result in human err.

The triggering events 318 that automatically result in fund reallocation may include predetermined future dates 320 or predetermined life goal account amount thresholds 322, such that funds are reallocated upon specified dates or upon the specified amounts being accumulated in the life goal account 308. In other embodiments of the invention the triggering event 318 may be meeting a predetermined target price for the goal 326 or a component of the life goal 324. In such embodiments of the invention, the lower uncertainty investment may be the actual purchase of the goal or the component of the goal, such that meeting the predetermined target price prompts purchase/acquisition of the goal or component if adequate funds exist in the life goal account 308 at the time the target price is determined to be met. In other embodiments of the invention, the triggering event 318 may be dynamic determination that an optimal price currently exists for goal component 328 or the goal 330. An optimal price may be determined by logic within the goal fund reallocation module 310 that determines if the current price is the lower than or substantially equal to future predicted prices, taking into account past pricing trends, interest rates and the like. Optimal price determinations may be especially beneficial when the goal is associated with a real estate purchase or the like, in which price fluctuations may cause the goal price to rise and/or fall over time. It should be noted that the triggering events 318 herein described are by way of example only and that other embodiments of the goal fund reallocation module 310 may configure other triggering events which result in automatic fund reallocation.

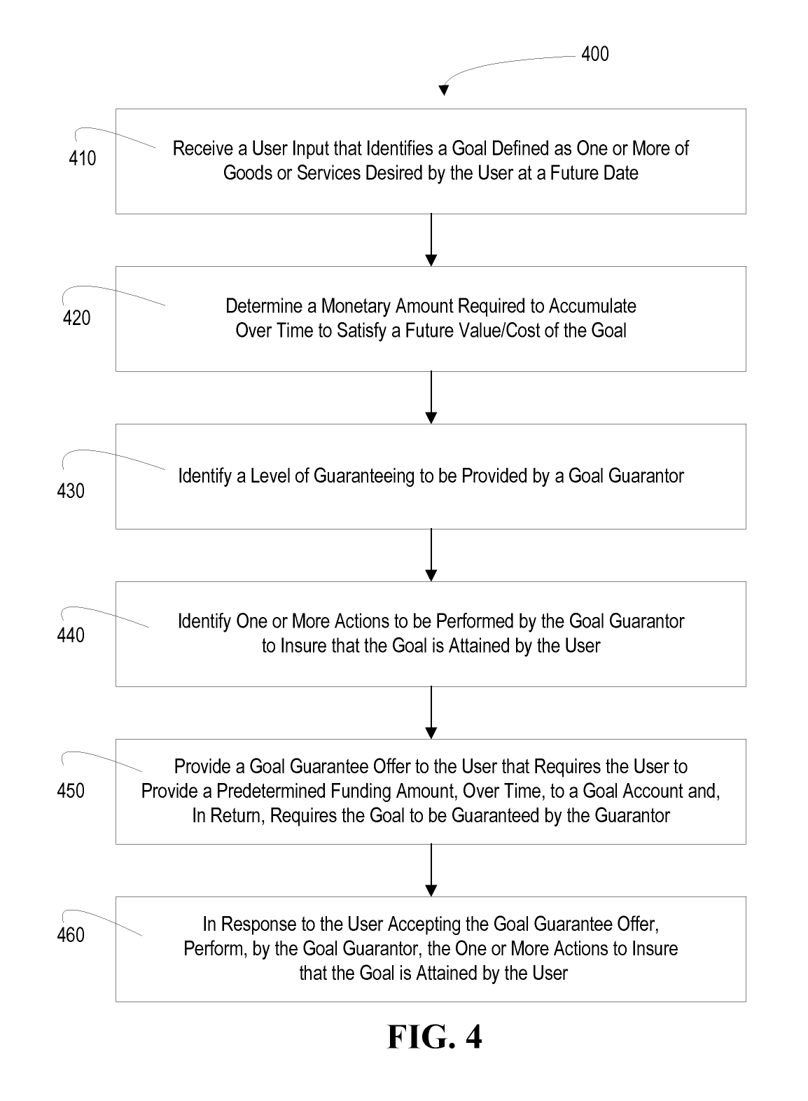

Referring to FIG. 4, a flow diagram is presented of a method 400 for establishing a guaranteed life goal, in accordance with embodiments of the present invention. At Event 410, a user input is received that identifies a life goal that the user desires to attain at a future date. As previously noted, the life goal is defined as be good(s) or services(s) or a combination of good(s) and services(s), with the definition of goods including real estate (real property, which may include a structure). The user input may provide for the user to define the life goal or the user may select the life goal and/or a life goal category from various life goal options. In addition, the user input may include user selection/input of the future date on which the life goal is to be realized or on which the life goal is to commence.

At Event 420, a monetary amount is determined that is required to be accumulated over time to satisfy the future value/cost of the life goal. Determining the monetary amount may initially include determine what the goal comprises or, more specifically, the components that make up the identified life goal. As the determination of the monetary amount predicts or otherwise assesses what the future value/cost of the life goal will be at the point in time at which the life goal will be purchased. It should be noted that the goal guarantor or other entity may purchase or otherwise acquire the life goal or components or the life goal prior to the future date on which the user/customer desires to attain/receive the life goal or the date on which the user/customer begins receiving the life goal. As such, determining the future value/cost takes into account a finite or predicted date on which the life goal is to be purchased and other factors associated with determining a future value cost, such as interest rates, inflation and the like. It should be noted that determination of the monetary amount may, in certain embodiments, be configured to occur in real-time or near-real time upon identification of the life goal, while in other embodiments of the invention the determination of the monetary amount may occur over a period of time, in due course, due to the complexity or other factors associated with the identified life goal.

At Event 430, a level of guaranteeing is identified for the user/customer. In specific embodiments the level of guaranteeing is defined as a percentage of the monetary amount need to be accumulated over time to satisfy the future value/cost of the life goal. The level of guaranteeing may be identified based on user selection or input of a desired the level of guaranteeing. In other embodiments of the invention, the level of guaranteeing may be guarantor determined based on the user's/customer's current financial performance (i.e., accessing the user's/customer's financial records/accounts and/or credit score). In specific embodiments of the invention, the guarantor's determination may result in which different levels of guarantee are presented to the user for selection. For example, strong financial historical performance may result in the user being presented level of guaranteeing options up to and including 100%, while weaker financial historical performance may result in the user being presented level of guaranteeing options less than 100% (e.g., up to 75%, up to 50% or the like).

At Event 440, actions 236 to be performed by the guarantor are to insure that the goal is attained by the user/customer are identified. As previously discussed the actions may include, but are not limited to, an insurance policy (and a related amount of insurance), timing of purchases and aggregated purchasing. In specific embodiments of the invention the actions taken by the guarantor may be determined and/or identified prior to making a goal guarantee offer to the user/customer, while in other embodiments, at least a portion, of the actions may be determined and/or identified after the goal guarantee has been established (e.g., specific timing of purchases and aggregated purchasing may not be identified until after the goal guarantee has been established). However, the amount of insurance required may factor into the predetermined funding amount 246 required of the user/customer (i.e., the overall cost of the goal guarantee) and, as such, the determination of the insurance policy amount, which may take into account such factors as the user's financial historical performance, credit score and level of guaranteeing, may occur prior to making the goal guarantee offer to the user/customer.

At Event 450, a goal guarantee offer is presented to the user/customer that requires the user/customer to provide a predetermined funding amount, over time, to a life goal and, as consideration for the predetermined funding amount, requires, at least a portion of the life goal to be guaranteed by the goal guarantor. Guaranteed means that the goal will be realized by the user/customer regardless of extraneous circumstances, such as loss of income/job, rises in cost related to the goal, and, in some embodiments, faulty investment strategy and the like. The predetermined funding amount, which may be regularly scheduled payments, such as monthly payments or the like, is determined based on the monetary amount, the level of guaranteeing and an uncertainty calculation associated with the user. In alternate embodiments of the invention, the predetermined funding amount may additionally be determined based on the guarantor actions and an uncertainty calculation associated with the goal.

At Event 460, in response to the user/customer accepting the goal guarantee offer, the determined guarantor actions (or actions determined/identified post-offer acceptance) are performed by the goal guarantor to insure that the life goal is attained by the user/customer.

Referring to FIG. 5 a flow diagram is presented of a method 500 for establishing a guaranteed life goal and providing for automatic reallocation of funds in the life goal account upon occurrence of a triggering event, in accordance with embodiments of the present invention. At Event 510, a goal guarantee is established for a user/customer that provides the user a guarantee of attaining/acquiring, at a future date, a life goal based on the user providing a predetermined funding amount over time to a life goal account. As previously discussed, the life goal may be good(s) or services(s) or a combination of good(s) and services(s), with goods including real estate (real property, which may include a structure).

The predetermined funding amount, which may be regularly scheduled payments, such as monthly payments or the like, is determined based on a predicted future value/cost of the goal and an uncertainty calculation associated with the user. In alternate embodiments of the invention, the predetermined funding amount may additionally be determined based on the guarantor actions, an uncertainty calculation associated with the goal and a level of guaranteeing.

At Event 520, at least a portion of the accumulated funds in the life goal account are automatically reallocated from a higher uncertainty investment to a lower risk investment in response to one or more predetermined fund reallocation triggering events. As previously discussed, fund reallocation may occur multiple times in the life of a goal guarantee, such that each instance of a triggering event may result in the funds being reallocated to a less uncertain investment. The triggering events that automatically result in fund reallocation may include predetermined future dates or predetermined life goal account amount thresholds, such that funds are reallocated upon specified dates or upon the specified amounts being accumulated in the life goal account. In other embodiments of the method the triggering event may be meeting a predetermined target price for the goal or a component of the life goal. In such embodiments of the invention, the lower uncertainty investment may be the actual purchase of the goal or the component of the goal, such that meeting the predetermined target price prompts purchase/acquisition of the goal or component if adequate funds exist in the life goal account at the time the target price is determined to be met. In other embodiments of the invention, the triggering event may be dynamic determination that an optimal price currently exists for goal component or the goal. An optimal price may be determined by logic that determines if the current price is the lower than or substantially equal to future predicted prices, taking into account past pricing trends, interest rates and the like.

Thus, systems, apparatus, methods, and computer program products described above provide for managing funds in a life goal account so insure the purchase of the goods, real estate and/or services associated with the goal. Since investment strategy for a life goal account typically provides for the funds to be invested in a higher uncertainty vehicle at the onset of the account, the present invention provides for automatically reallocating the funds from a higher uncertainty investment vehicle/account to a lower uncertainty investment vehicle account in response to a triggering event. The triggering event may be predetermined date(s), predetermined threshold amounts, predetermined target price(s) for the goal or components of the goal, or dynamic determination of a current price being optimal for buying/acquiring the goal or components of the goal.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for managing funds in a life goal account, the system comprising:
an apparatus comprising a computing platform including a memory and at least one processor in communication with the memory;
a goal guarantee module, stored in the memory executable by the processor and configured to provide a user a guarantee of acquiring, at a future date, a life goal desired by the user based on the user providing a predetermined funding amount over time to a life goal account, wherein the goal includes one or more of tangible goods, real estate or services and wherein the predetermined funding amount is determined based at least in part on a predicted future cost for the goal and an uncertainty calculation associated with the user.
a goal fund reallocation module, stored in the memory, executable by the processor and configured to automatically reallocate at least a portion of funds accumulated in the life goal account from a higher uncertainty investment to a lower uncertainty investment in response to one or more predetermined triggering events.

2. The system of claim 1, wherein the goal fund reallocation module is further configured to automatically reallocate at least a portion of the funds accumulated in the life goal account from the higher uncertainty investment to the lower uncertainty investment in response to the one or more predetermined triggering events, wherein the triggering events are predetermined dates.

3. The system of claim 1, wherein the goal fund reallocation module is further configured to automatically reallocate at least a portion of the funds accumulated in the life goal account from the higher uncertainty investment to the lower uncertainty investment in response to the one or more predetermined triggering events, wherein the triggering events are predetermined amount thresholds accumulated in the life goal account.

4. The system of claim 1, wherein the goal fund reallocation module is further configured to automatically reallocate at least a portion of the funds accumulated in the life goal account from the higher uncertainty investment to the lower uncertainty investment in response to the one or more predetermined triggering events, wherein the triggering events is one of meeting a predetermined target prices for acquiring components that comprise the goods, real estate or services defining the goal or logical determination that an optimal price currently exists for acquiring components that comprise the goods, real estate or services defining the goal.

5. The system of claim 4, wherein the goal fund reallocation module is further configured to reallocate a remaining balance of the funds accumulated in the life goal account from the higher uncertainty investment to the lower uncertainty investment in response to acquiring the components at one of the predetermined target price or the determined optimal price.

6. The system of claim 1, wherein the goal fund reallocation module is further configured to automatically reallocate at least a portion of funds accumulated in the life goal account from a higher uncertainty investment to a lower uncertainty investment in response to one or more predetermined triggering events, wherein the lower uncertainty investment is acquisition of the goods, real estate or services that comprise the goal.

7. The system of claim 6, wherein the goal fund reallocation module is further configured to automatically reallocate at least a portion of the funds accumulated in the life goal account from the higher uncertainty investment to the lower uncertainty investment in response to the one or more predetermined triggering events, wherein the triggering events is one of meeting a predetermined target prices for acquiring the goods, real estate or services defining the goal or logical determination that an optimal price currently exists for acquiring the goods, real estate or services defining the goal.

8. A method for managing funds in a life goal account, the method comprising:
establishing a goal guarantee for a user that provides the user a guarantee of acquiring, at a future date, a life goal based on the user providing a predetermined funding amount over time to a life goal account, wherein the goal includes one or more of tangible goods, real estate or services and wherein the predetermined funding amount is determined based at least in part on a predicted future cost for the goal and an uncertainty calculation associated with the user; and
automatically reallocating at least a portion of funds accumulated in the life goal account from a higher uncertainty investment to a lower uncertainty investment in response to one or more predetermined triggering events.

9. The method of claim 8, wherein automatically reallocating further comprises automatically reallocating at least a portion of the funds accumulated in the life goal account from the higher uncertainty investment to the lower uncertainty investment in response to the one or more predetermined triggering events, wherein the triggering events are predetermined dates.

10. The method of claim 8, wherein automatically reallocating further comprises automatically reallocating at least a portion of the funds accumulated in the life goal account from the higher uncertainty investment to the lower uncertainty investment in response to the one or more predetermined triggering events, wherein the triggering events are predetermined amount thresholds accumulated in the life goal account.

11. The method of claim 8, wherein automatically reallocating further comprises automatically reallocating at least a portion of the funds accumulated in the life goal account from the higher uncertainty investment to the lower uncertainty investment in response to the one or more predetermined triggering events, wherein the triggering events is one of meeting a predetermined target prices for acquiring components that comprise the goods, real estate or services defining the goal or logical determination that an optimal price currently exists for acquiring components that comprise the goods, real estate or services defining the goal.

12. The method of claim 11, wherein automatically reallocating further comprises automatically reallocating a remaining balance of the funds accumulated in the life goal account from the higher uncertainty investment to the lower uncertainty investment in response to acquiring the components at one of the predetermined target price or the determined optimal price.

13. The method of claim 8, wherein automatically reallocating further comprises automatically reallocating at least a portion of funds accumulated in the life goal account from a higher uncertainty investment to a lower uncertainty investment in response to one or more predetermined triggering events, wherein the lower uncertainty investment is acquisition of the goods, real estate or services that comprise the goal.

14. The method of claim 13, wherein automatically reallocating further comprises automatically reallocating at least a portion of the funds accumulated in the life goal account from the higher uncertainty investment to the lower uncertainty investment in response to the one or more predetermined triggering events, wherein the triggering events is one of meeting a predetermined target prices for acquiring the goods, real estate or services defining the goal or logical determination that an optimal price currently exists for acquiring the goods, real estate or services defining the goal.

15. A computer program product comprising:
a non-transitory computer-readable medium comprising:
a first set of codes for causing a computer to establishing a goal guarantee for a user that provides the user a guarantee of acquiring, at a future date, a life goal based on the user providing a predetermined funding amount over time to a life goal account, wherein the goal includes one or more of tangible goods, real estate or services and wherein the predetermined funding amount is determined based at least in part on a predicted future cost for the goal and an uncertainty calculation associated with the user; and
a second set of codes for causing a computer to automatically reallocate at least a portion of funds accumulated in the life goal account from a higher uncertainty investment to a lower uncertainty investment in response to one or more predetermined triggering events.

16. The computer program product of claim 15, wherein the second set of codes is further configured to cause the computer to automatically reallocate at least a portion of the funds accumulated in the life goal account from the higher uncertainty investment to the lower uncertainty investment in response to the one or more predetermined triggering events, wherein the triggering events are predetermined dates.

17. The computer program product of claim 15, wherein the second set of codes is further configured to cause the computer to automatically reallocate at least a portion of the funds accumulated in the life goal account from the higher uncertainty investment to the lower uncertainty investment in response to the one or more predetermined triggering events, wherein the triggering events are predetermined amount thresholds accumulated in the life goal account.

18. The computer program product of claim 15, wherein the second set of codes is further configured to cause the computer to automatically reallocate at least a portion of the funds accumulated in the life goal account from the higher uncertainty investment to the lower uncertainty investment in response to the one or more predetermined triggering events, wherein the triggering events is one of meeting a predetermined target prices for acquiring components that comprise the goods, real estate or services defining the goal or logical determination that an optimal price currently exists for acquiring components that comprise the goods, real estate or services defining the goal.

19. The computer program product of claim 18, wherein the second set of codes is further configured to cause the computer to automatically reallocate a remaining balance of the funds accumulated in the life goal account from the higher uncertainty investment to the lower uncertainty investment in response to acquiring the components at one of the predetermined target price or the determined optimal price.

20. The computer program product of claim 15, wherein 13. The method of claim 8, wherein automatically reallocating further comprises automatically reallocating at least a portion of funds accumulated in the life goal account from a higher uncertainty investment to a lower uncertainty investment in response to one or more predetermined triggering events, wherein the lower uncertainty investment is acquisition of the goods, real estate or services that comprise the goal.
